(19) United States
(12) Patent Application Publication
(10) Pub. No.: US 2017/0215232 A1
(43) Pub. Date: Jul. 27, 2017

(54) UNIT FOR HEATING HOLLOW BODIES, WHICH COMPRISES A LOW-TEMPERATURE CAVITY

(71) Applicant: SIDEL PARTICIPATIONS, Octeville-sur-mer (FR)

(72) Inventor: Guy FEUILLOLEY, Octeville-sur-mer (FR)

(21) Appl. No.: 15/328,286

(22) PCT Filed: Jul. 17, 2015
(86) PCT No.: PCT/FR2015/051975

§ 371 Date: Jan. 23, 2017

(30) Foreign Application Priority Data
Jul. 23, 2014 (FR) 1457118

(51) Int. Cl. H05B 3/00; B29C 35/08; B29C 49/64; B29C 49/68

(52) U.S. Cl. CPC H05B 3/0057; B29C 49/68; B29C 35/0805; B29C 49/6418; B29C 2035/0838

(57) ABSTRACT

Unit (1) for heating hollow body preforms (2) made of plastic, which includes a cavity (8) through which the preforms (2) file past and includes: an emitter device (12) equipped with at least one radiant source (13) of electromagnetic radiation pointing toward the cavity (8); a structure (7) delimiting the cavity (8) and including a set of components (9, 10, 11) forming the boundaries thereof, each boundary component (9, 10, 11) being provided with an internal face (14, 15, 16, 17), facing towards the cavity (8) and capable of absorbing the electromagnetic radiation emanating from the emitter device (12) or reflecting it towards the cavity (8); a cooling circuit (18) formed in its entirety outside of the cavity (8), which includes a fluid canal (19) through which a heat-transfer fluid passes, each boundary component (9, 10, 11) being in thermal contact with a fluid canal (19).

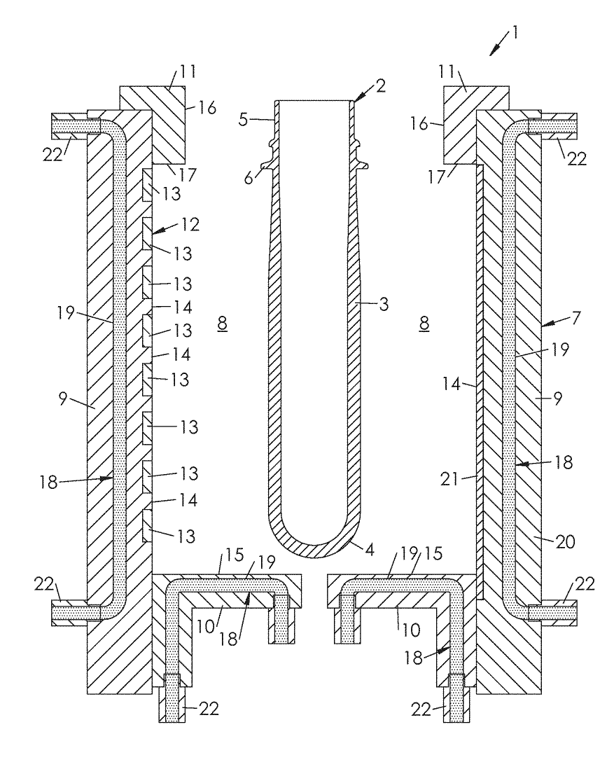

The invention relates to the thermal (or heat) treatment of hollow bodies made of plastic material, in particular blanks of containers (such as bottles, jars, flasks)—with the term “blank” designating either a preform, obtained by injection of a plastic material into a mold, or an intermediate hollow body that is obtained from a preform that has undergone at least a first forming operation and that is designed to undergo at least a second operation.

The thermal treatment is in general carried out in a stream within a heating unit, commonly called a furnace, comprising at least one electromagnetic radiation source and walls delimiting a cavity into which the blanks travel, with at least one of the walls comprising at least one reflector that is turned toward the cavity and that is capable of reflecting the radiation toward it.

A conventional heating technique consists in using tubular halogen-type incandescent lamps, radiating according to Planck's Law over a continuous spectrum.

This technique, very widely used, is not without drawbacks. In addition to the fact that a large portion of the electrical energy consumed by the lamps is wasted as thermal energy, a large rise in the temperature of the walls bordering the cavity is noted because of their absorption of a portion of the energy emitted by the lamps.

The result is a rise in the temperature of the ambient air in the cavity, requiring cooling. This is generally carried out by means of a forced circulation of a heat-transfer fluid—in general air that is pulsed by means of ventilation—in the cavity, to regulate the temperature of the ambient air. This technique, illustrated in particular by the French patent FR 2 863 931 (Sidel) and its U.S. equivalent U.S. Pat. No. 7,448,866, works fairly well but can be improved in particular for the following reasons:
It is difficult to achieve a fine regulation of the ambient temperature in the cavity starting from such a ventilation,
The transitory phases of starting and stopping are long because of the gradual rise (or drop) in temperature of the heating unit, to the detriment of productivity,
The side walls reemit toward the cavity a portion of the energy that is absorbed in infrared form and consequently are comprised as radiant heating elements that disrupt the heating profile anticipated for the hollow bodies,
The side walls remain hot despite the ventilation, which requires, with each maintenance procedure on the heating unit, allowing the walls to return to the ambient temperature making possible a handling of the parts without a risk of burning;
Accelerated wear and tear of parts of the walls, because of thermal fatigue phenomena;
The ventilation in the cavity makes it necessary to provide wide openings, by which radiation can escape outside of the cavity, to the detriment of the yield and the safety of the nearby personnel.

One objective is consequently to eliminate these drawbacks.

For this purpose, a unit for heating blanks of hollow bodies made of plastic material is proposed, which includes a cavity in which the blanks travel and which comprises:
An emitter device equipped with at least one radiant source of electromagnetic radiation pointing toward the cavity;
A frame delimiting the cavity and comprising a set of parts forming the boundaries thereof, each boundary part being equipped with an inner face, turned toward the cavity and capable of absorbing the electromagnetic radiation obtained from the emitter device or of reflecting it toward the cavity;
A cooling circuit that is formed in its entirety outside of the cavity and that comprises a fluid channel through which a heat-transfer fluid passes, each boundary part being in thermal contact with a fluid channel.

Various additional characteristics can be provided, by themselves or in combination:
The channel is a pipe with a closed contour that extends inside a boundary part;
The heat-transfer fluid is liquid;
A boundary part is a side wall that transversely delimits the cavity, and an inner face of which reflects electromagnetic radiation;
A boundary part is a reflector delimiting the cavity toward the bottom and an inner face of which reflects electromagnetic radiation;
A boundary part is an absorber of which a main inner face, which forms an upper side edge of the cavity, is absorbent for the electromagnetic radiation;
The absorber has a secondary inner face that is adjacent to the main inner face and that reflects electromagnetic radiation;
The or each radiant source is a laser;
The or each radiant source is a laser diode;
The emitter device is equipped with a VCSEL-type laser diode matrix.

Other objects and advantages of the invention will be brought out in the description of an embodiment, given below with reference to the accompanying FIGURE, which is a cutaway view of a unit 1 for heating blanks 2 of hollow bodies made of plastic material.

In the (non-limiting) example illustrated, the blanks 2 are preforms that are designed, once softened by heating, to undergo a blow-molding or stretch-blow-molding operation in a mold for forming a container such as a bottle. Each preform 2 comprises an essentially cylindrical body 3, a hemispherical bottom 4 closing the body 3 at its lower end, and a neck 5 that extends the body 3 at its upper end. The neck 5 is separated from the body 3 by a collar 6 that is used in particular as a means for indexing and support during the handling of the preform 2.

The blanks 2 could also be intermediate containers, known in the art and obtained during a preliminary blow-molding or stretch-blow-molding stage from preforms such as those that were just described. They are containers that, for various reasons, require an additional thermal treatment. Like the preforms, such intermediate containers would comprise a body 3, a bottom 4 closing the body 3 at its lower end, and a neck 5 that would extend the body 3 at its upper end by being separated from the body 3 by a collar 6 that can be used in particular as a means for indexing and support during the handling of this container. The neck 5 and the collar 6 of such an intermediate container are those present on the preform that make it possible to obtain it.

The heating unit 1 comprises a frame 7 that delimits a tunnel-shaped cavity 8 into which blanks 2 (here preforms) travel behind one another. The frame 7 comprises a set of parts 9, 10, 11 that form the boundaries of the cavity 8, i.e., these parts 9, 10, 11 are located at the edges of the cavity 8, for which they form the spatial boundaries in any transverse plane that is perpendicular—at least locally—to the direction of travel of the blanks 2. In other words, a part is said to be a boundary part since it has an inner face that delimits (at least locally) the cavity 8.

Among the boundary parts, the following are included, in particular:
A side wall 9, which transversely delimits the cavity 8 opposite the bodies 3 of the blanks 2,
A lower reflector 10, which delimits the cavity 8 toward the bottom, perpendicular to the bottom 4 of the blanks 2,
An absorber 11 (in the electromagnetic sense of the term, as we will see below), which transversely delimits the cavity 8 opposite the necks 5 of the blanks 2.

In the example illustrated, the frame 7 comprises two opposite side walls 9, two lower reflectors 10 each mounted on a side wall 9, at the same height, and two absorbers 11, also each mounted on a side wall 9 at the same height.

The heating unit 1 also comprises an emitter device 12, equipped with at least one radiant source 13 of electromagnetic radiation pointing toward the cavity 8.

The term “radiant” means that the radiation source 13 is arranged to transmit the caloric energy to the blank 2 without using the air as a transmission vector.

According to an embodiment, the (or each) source 13 emits in the microwave range at a wavelength of between approximately 1 mm and 30 cm.

According to another embodiment, the (or each) source 13 emits in the near-infrared range at a wavelength of between approximately 800 nm and 2,000 nm, and, for example, on the order of 1,000 nm.

In the example illustrated, the emitter device 12 comprises a number of identical sources 13 that point toward the cavity 8. Each source 13 is, for example, a laser, such as a laser diode, in particular of the VCSEL (vertical-cavity surface-emitting laser) type, which makes possible an organization of the sources 13 in matrix form.

So as to confine the radiation to the cavity 8, in such a way as to optimize the yield of the heating and to prevent the radiation from being dispersed outside of the cavity 8 (in particular to safeguard the personnel), each boundary part 9, 10, 11 is equipped with an inner face turned toward the cavity 8, at its boundary, that is capable of:
Absorbing the electromagnetic radiation obtained from the emitter device 12, or
Reflecting this radiation toward the cavity 8.

Thus, the or each side wall 9 has an inner face 14 that reflects electromagnetic radiation. In the example illustrated, the inner face 14 of the side wall 9 extends vertically, opposite the bodies 3 of the blanks 2, to reflect toward the former the radiation that is obtained from the emitter device 12. At least one of the side walls 9 can, as in the example illustrated, carry or even integrate the emitter device 12. In this case, the reflective inner face 14 can extend around the emitter device 12, vertically and/or horizontally (for example, in the manner of a frame).

According to an embodiment, the side walls 9 are similar and each carry (or integrate) an emitter device 12. The emitter devices 12 can be placed in staggered rows, with a reflective face 14 in this case being placed opposite each emitter device 12 of the opposite side wall 9 to reflect toward the cavity 8 a fraction of the radiation that is not absorbed directly by the blanks 2.

The lower reflector 10 also has an inner face 15 that reflects electromagnetic radiation. In the example illustrated, the inner face 15 of the lower reflector 10 extends horizontally, opposite the bottom 4 of the blanks 2, to reflect toward the former the radiation that is obtained from the emitter device 12 and thus also to improve the yield of the heating.

The absorber 11 has a main inner face 16 that forms an upper side edge of the cavity 8 and that is absorbent for electromagnetic radiation. In the example illustrated, this main inner face 16 extends vertically, opposite the necks 5 of the blanks 2, to absorb the radiation that is obtained from the emitter device(s) 12 and to minimize the part of the former reaching the necks 5 or escaping from the cavity 8. The main inner face 16 is formed by, for example, an absorbent coating such as a black paint.

According to an embodiment illustrated in the accompanying FIGURE, the absorber 11 also has a secondary inner face 17 that is adjacent to the main inner face 16 and that reflects electromagnetic radiation. In the example illustrated, the secondary inner face 17 extends horizontally and is oriented toward the bottom, in such a way as to confine the radiation from the emitter device 12 in the cavity 8 as much as possible and to minimize the portion of the former that escapes therefrom.

Each reflective face 14, 15, 17 is formed by, for example, polishing. As a variant, a reflective face 14, 15, 17 can be formed by a metal coating, for example in the form of a thin layer of gold, silver, aluminum, or any other material that offers a good specular reflection coefficient for the wavelengths of the radiation emitted by the emitter device. Such a coating can be obtained by vapor phase deposition, physical (PVD, typically by cathode sputtering) or chemical (CVD).

In the absence of thermal regulation, the absorption of the radiation by the absorbent face 16 of the absorber 11 brings about a rise in temperature of the former. Likewise, no reflective face 14, 15, 17 has perfect optical properties to the point where it reflects all of the radiation in such a way that a portion (even small) of the former is absorbed in the boundary part 9, 10, 11, which thus sees its temperature rise.

This heating is able to bring about, beyond a certain temperature, the generation by each boundary part 9, 10, 11 of an infrared radiation that, retransmitted toward the cavity 8, is able to disrupt the heating profile that it is desired to impart to the blanks 2.

This is why the heating unit 1 is equipped with a cooling circuit 18, which comprises at least one fluid channel 19 through which a heat-transfer fluid passes.

As can be seen in the accompanying FIGURE, the cooling circuit 18 is formed in its entirety outside of the cavity 8, i.e., outside of the volume delimited by the inner (reflective or absorbent) faces 14, 15, 16, 17 of the boundary parts 9, 10, 11.

Furthermore, as is also seen in this FIGURE, each boundary part 9, 10, 11 is in thermal contact with a fluid channel 19.

In the example illustrated, each boundary part 9, 10, 11 is provided with a fluid channel 19 through which the heat-transfer fluid passes. This fluid channel 19 extends at least locally in the vicinity of the inner face 14, 15, 16, 17 to promote the heat exchange with the former.

Each boundary part 9, 10, 11 is made of a material that is a good heat conductor, for example in a metal material such as steel, copper, aluminum, or alloys thereof, so as to make possible a good heat exchange with the fluid channel 19.

If the boundary part 9, 10, 11 consists of a single piece, the thermal contact is ensured by the material that separates the channel 19 from the inner face 14, 15, 16, 17. If the boundary part 9, 10, 11 in contrast comprises a support 20 and a connected element 21 that at least partially integrates the inner face 14, 15, 16, 17 (as in the illustrated example where the side wall 9 that is located on the right in the FIGURE comprises a connected plate 21 that forms the reflective inner face 14), the thermal contact between the inner face 14, 15, 16, 17 and the channel 19 is ensured by the contact between the connected element 21 and the support 20, which then forms a thermal bridge.

According to an illustrated embodiment, each boundary part 9, 10, 11 integrates its own fluid channel 19; it involves, for example, a pipe with a closed contour that extends into the interior of the boundary part 9, 10, 11, in part in the vicinity of the inner face 14, 15, 16, 17.

The heat-transfer fluid, shown in shaded form in the FIGURE, is preferably liquid (achieving a more effective heat exchange than a gas), for example water. The temperature of the liquid upon entering into the pipe is, for example, between 15° C. and 25° C., in such a way as to keep the boundary part 9, 10, 11 at a temperature that is less than or equal to 40° C. (and preferably less than 30° C.).

As can be seen in the accompanying FIGURE, connectors 22 can be provided to ensure the connection of the (of each) channel 19 with hoses (not shown) for supplying and discharging fluid.

As a variant, the channel 19 can be formed by fins that project onto an outer face of the boundary part 9, 10, 11, with the heat-transfer fluid then being a pulsed gas (for example air) that circulates in a forced manner in the fins to cool the boundary part 9, 10, 11.

Be that as it may, the heat exchange between the heat-transfer fluid and the boundary part 9, 10, 11 makes it possible to ensure thermal regulation of the boundary part 9, 10, 11 (and more specifically of the inner face 14, 15, 16, 17) to a relatively low predetermined temperature (lower, as we will see, than 40° C.).

The following advantages result therefrom:
The relatively cold boundary parts 9, 10, 11 reemit only little (or no) infrared radiation toward the cavity 8, which avoids disrupting the heating profile of the blanks 2;
The boundary parts 9, 10, 11 no longer entrain parasitic heating of the cavity 8 by thermal convection, in such a way that it is not necessary to ensure cooling by forced circulation of air inside the cavity 8 itself;
In the absence of such ventilation, it is not necessary to provide openings for the passage of the air, which makes it possible to better confine the radiation and thus to increase the yield of the heating while protecting the nearby personnel;
The boundary parts 9, 10, 11 are subjected to less thermal fatigue, thus improving their service life and the reliability of the heating unit 1;
It is possible to achieve a fine regulation of the ambient temperature in the cavity 8 in the absence of parasitic radiation due to the boundary parts 9, 10, 11, thus improving the heating precision;
The phases of temperature rise and cooling of the heating unit 1, respectively to the launching of the heating cycle and the termination thereof, are of short duration, thus improving, respectively, the productivity and the response time of the maintenance personnel;
The maintenance operations can be conducted quickly and without running the risk of burning.

1. Unit (1) for heating blanks (2) of hollow bodies made of plastic material, which includes a cavity (8) in which the blanks (2) travel and which comprises:
An emitter device (12) equipped with at least one radiant source (13) of electromagnetic radiation pointing toward the cavity (8);
A frame (7) delimiting the cavity (8) and comprising a set of parts (9, 10, 11) forming the boundaries thereof, each boundary part (9, 10, 11) being equipped with an inner face (14, 15, 16, 17), turned toward the cavity (8) and capable of absorbing the electromagnetic radiation obtained from the emitter device (12) or of reflecting the electromagnetic radiation toward the cavity (8);
A cooling circuit (18) that comprises a fluid channel (19) through which a heat-transfer fluid passes;
wherein
the cooling circuit (18) is formed in its entirety outside of the cavity (8), and each boundary part (9, 10, 11) is in thermal contact with a fluid channel (19), with the channel (19) being a pipe with a closed contour that extends into the interior of the boundary part (9, 10, 11).

2. Heating unit (1) according to claim 1, wherein a boundary part (9) is a side wall that transversely delimits the cavity (8), and an inner face (14) of which reflects electromagnetic radiation.

3. Heating unit (1) according to claim 1, wherein a boundary part (10) is a reflector that delimits the cavity (8) toward the bottom and an inner face (15) of which reflects electromagnetic radiation.

4. Heating unit (1) according to claim 1, wherein a boundary part (11) is an absorber of which a main inner face (16), which forms an upper side edge of the cavity (8), is absorbent for electromagnetic radiation.

5. Heating unit (1) according to claim 4, wherein the absorber (11) has a secondary inner face (17) that is adjacent to the main inner face (16) and that reflects electromagnetic radiation.

6. Heating unit (1) according to claim 1, wherein the or each radiant source (13) is a laser.

7. Heating unit (1) according to claim 6, wherein the or each radiant source (13) is a laser diode.

8. Heating unit (1) according to claim 7, wherein the emitter device (12) is equipped with a VCSEL-type laser diode matrix.

9. Heating unit (1) according to claim 2, wherein a boundary part (10) is a reflector that delimits the cavity (8) toward the bottom and an inner face (15) of which reflects electromagnetic radiation.

10. Heating unit (1) according to claim 2, wherein a boundary part (11) is an absorber of which a main inner face (16), which forms an upper side edge of the cavity (8), is absorbent for electromagnetic radiation.

11. Heating unit (1) according to claim 3, wherein a boundary part (11) is an absorber of which a main inner face (16), which forms an upper side edge of the cavity (8), is absorbent for electromagnetic radiation.

12. Heating unit (1) according to claim 2, wherein the or each radiant source (13) is a laser.

13. Heating unit (1) according to claim 3, wherein the or each radiant source (13) is a laser.

14. Heating unit (1) according to claim 4, wherein the or each radiant source (13) is a laser.

15. Heating unit (1) according to claim 5, wherein the or each radiant source (13) is a laser.

16. Heating unit (1) according to claim 9, wherein a boundary part (11) is an absorber of which a main inner face (16), which forms an upper side edge of the cavity (8), is absorbent for electromagnetic radiation.

17. Heating unit (1) according to claim 9, wherein the or each radiant source (13) is a laser.

18. Heating unit (1) according to claim 10, wherein the or each radiant source (13) is a laser.

19. Heating unit (1) according to claim 11, wherein the or each radiant source (13) is a laser.
